(19) United States
(12) Patent Application Publication
(10) Pub. No.: US 2025/0353242 A1
(43) Pub. Date: Nov. 20, 2025

(54) Stretching Device and Method for Stretching a Plastic Film in the Transport Direction Thereof

(71) Applicant: Windmöller & Hölscher KG, Lengerich (DE)

(72) Inventors: Henning Steuter, Lengerich (DE); Jens Goldenstein, Lengerich (DE)

(21) Appl. No.: 18/294,457

(22) PCT Filed: Jul. 13, 2022
(86) PCT No.: PCT/EP2022/069635

§ 371 Date: Feb. 1, 2024

(30) Foreign Application Priority Data
Jul. 19, 2021 (DE) 10 2021 207 658.0

(51) Int. Cl. B29C 55/06; B29C 71/00

(52) U.S. Cl. CPC B29C 55/06; B29C 71/0081

(57) ABSTRACT

The invention describes a stretching device for stretching a plastic film in its the transport direction, comprising a first roller (SD) over which the plastic film can be guided and which can be driven with a first drive and which can be rotated at a first circumferential speed, and comprising a second roller (FD) over which the plastic film can be guided and which can be driven with a second drive and which can be rotated at the second circumferential speed, wherein the second circumferential speed is greater than the first circumferential speed, wherein the second roller is arranged downstream of the first roller in the transport path of the plastic film, so that the plastic film can be stretched in the free region between the first and the second roller.

At least one first electrode, to which a first electrical potential can be applied and which is arranged in the angular region of the first roller, on which the plastic film rests, and/or upstream of said angular region, and that a second electrical potential can be applied to the first roller, should be emphasized.

The invention relates to a stretching device and a method for stretching a plastic film in its the transport direction.

Such a stretching device serves to influence the properties of a plastic film in a targeted manner. Such a stretching changes, in particular, the orientation of the molecules contained in the plastic film (hereafter also referred to as “film” for short). To bring about a stretching, the stretching device comprises a first roller which can be driven with first drive and can be rotated at a first circumferential speed. Furthermore, the stretching device comprises a second roller which can be driven with at second drive and can be rotated at a second circumferential speed. In the transport path of the plastic film, the second roller is arranged downstream of the first roller.

The plastic film is then stretched in that the second circumferential speed is greater than the first circumferential speed. Typically, the second circumferential speed is at least twice that of the first circumferential speed. The ratio of the circumferential speeds also constitutes the so-called stretch ratio.

However, various problems can occur during the stretching. For example, properties of the film, in particular, geometric properties such as the thickness profile in a direction transverse to the transport direction of the film, and also the flatness of the film may change due to the stretching. Particularly edge thickening can be observed in stretched films, with a simultaneous narrowing of the film width compared to the initial state, which is also referred to as neck-in or constriction. The result thereof is that the edges of the film must be cut off which leads to both undesirable waste and high costs.

The object of the present invention is therefore to propose a stretching device and a method with which at least some of the problems mentioned can be avoided.

According to the invention, this object is achieved by all of the features of claim 1. Possible embodiments of the invention are specified in the dependent claims.

According to the present invention it is provided that at least one first electrode, to which a first electrical potential can be applied and which is arranged in the angular region of the first roller, on which the plastic film rests, and/or upstream of said angular region, and that a second electrical potential can be applied to the first roller.

The first and the second roller are rollers that each can be partially wrapped by the film. The film meets the roller at a leading edge (which is not necessarily linear), is guided over an angular region and leaves the roller at a trailing edge or release edge. Between trailing edge of the first roller and the leading edge of the second roller, the film is guided unsupported and stretched in the process. This means, in particular, that there is no further guiding element such as a further roller in this intermediate region. This region is also referred to as stretching gap.

For the purpose of the invention, the electrode preferably comprises an electrical conductor, which, in particular comprises a metal, the conductor being fastened in an enclosure which at least partially consists of an electrically insulating material. The electrode is connected to parts of a machine frame via the enclosure. The electrical conductor faces the film, with the space between the electrical conductor and the film being free. The electrical conductor may be designed in the form of a plurality of pins, needles or even plated-shaped (hereinafter referred to as plate), the ends, tips or dished ends of which point toward the film. Preferably, a plurality of pins, needles or plates is arranged in one row or in a plurality of parallel rows which point transversely to the transport direction of the film. The distance of the pins, needles or plates is preferably less than 20 mm, preferably less than 10 mm and, in particular, less than 5 mm, to bring about the most homogeneous electric fields possible on the surface of the film. Said pins, needles or plates are, in particular, connected to one another with one or a plurality of wires. Pins or wires are able to generate very high electric fields at their ends facing the film. One or more wires facing the film may also be provided. The advantage of a wire can be that it can bring about a homogeneous electric field. A wire may preferably be arranged transverse to the transport direction of the film, but it may also be bent helically or wedge-shaped. Ribbon-like electrical conductors may also be provided that are not made of a metal but comprise materials that have a significantly lower conductivity than metal. Additionally or alternatively, conductive ceramics may also be considered as electrical conductors in electrodes.

An electrode further comprises an electric supply line and/or and electrical connection. An electrode may be a charging electrode, which releases or absorbs no or only a small amount of charge carriers, or a discharging electrode, which intentionally releases charge carriers and can therefore directly electrically charge the film.

Within the scope of the invention, the term “electrical conductor” or the term “electrically conductive” means that an electrical conductivity of at least 1 S/m (Siemens per meter) is present. If the conductivity is below said value, the term “non-conductor” or “insulating material” is used in the context of the invention.

An electrical charge, which is, in particular variable, can be applied to the electrode by means of an electric generator. In principle, the electrical charge may positive or negative, or by being applied with alternating current, may also periodically switch polarity. When an electrical charge is applied to the electrode, an electrical potential is applied to the electrode relative to the surroundings.

A plurality of first electrodes may be provided. This means, that a plurality of first electrodes may be successively arranged in the transport direction of the film to increase the influence on the film as described further below. All electrodes may have the same electrical potential. However, it may, in particular, be provided to apply different potentials to the first electrodes to, in this way, be able to more precisely control the influence on the film.

According to the invention, it is further provided that an electrical potential can also be applied to the first roller. Preferably, the electrical potential of the roller differs from that of the electrode so that an electrical voltage exists between the electrode and the roller which brings about an electric field. However, the first roller is, in particular, earthed so that the electrical potential is zero, i.e. is at ambient potential. For this purpose, it is advantageous if the roller is configured to be electrically conductive.

All rollers described for the purpose of the disclosure can be configured to be at least partially electrically conductive so that the electrical potential is created at the outer surface. Electrically conductive components leading to the surroundings and, in particular, to a generator, may be a rotary bearing of the roller or a sliding contact. Earthing, in particular, can also be achieved by conducting currents via a tempering fluid for tempering the roller or the roller interior. All described rollers may also be provide with a coating to prevent damaging, in particular scratching, the film.

In its entirety, the above describe arrangement results in an electric field acting on the film, which electric field induces an electric charge shift within the film, which is generally non-conductive. Alternatively or additionally, electric charges can be applied to the film, i.e., electric charge carriers can be added or removed. For this, the film is (additionally) held on the surface of the first roller with an electrical force. The result thereof is that the film is guided over the entire angular region, in particular in its edge region. The constriction or thickening of the edge that often occurs in front of the release edge can thus be reduced. If the electrode is arranged near or even upstream of the first roller and, in particular, of the leading edge of the first roller, then the additional electrical force toward the roller has the effect that less air entrained by the film can enter the area between film and roller. The reduced air volume compared to the state of the art further improves the effect of reduced edge thickening and constriction.

In a further improved embodiment of the invention, it is provided that at least one second electrode, to which a third electrical potential can be applied and which is arranged in the angular region of the second roller, on which the plastic film rests, and that a fourth electrical potential can be applied to the second roller. Under the prerequisite that the first and second rollers rotate in opposite directions, this means that the reverse side of the film can now be influenced with an electrical potential. The polarity of the third electrical potential is, in particular, opposite to the first electrical potential here so that the influence on the film is again increased. This accomplishes, in particular, that the edge regions of the film are preferably immediately also subject to a force toward the second roller. The leading edge is consequently preferably linear. For this purpose, it is advantageous that the second electrode is arranged in the region, or as viewed in the transport direction of the film, directly behind the leading edge.

A plurality of second electrodes may be provided. This means, that a plurality electrodes may be successively arranged in the transport direction of the film to increase the described influence on the film. All second electrodes may have the same electrical potential. However, it may, in particular, be provided to apply different potentials to the second electrodes so that the influence on the film can be controlled more precisely.

It is further advantageous, if at least one third electrode is provided to which a fifth electrical potential can be applied and which is arranged in the angular region of the second roller, on which the plastic film rests, and downstream of the second electrode, wherein the fifth electrical potential has a reverse polarity compared to the third potential. However, the potential may have a different value. The advantage of a third electrode is that the charge shift within the film, which is caused by the first electrode and—if provided—by the second electrode, can be at least partially reversed. Therefore, the term “compensation charge” is also used below. This means that the film is no longer subjected to an electrical force toward the roller in the region of the release edge of the second roller, making it easy to detach. Typically, following rollers rotate relative to the second roller with comparable circumferential speeds so that only a low pulling force acts on the film. In principle, providing an electrode for compensating the charge of the film is also conceivable with a different than the second roller.

In an embodiment of the invention providing further advantages, at least one fourth electrode is provided to which a sixth electrical potential can be applied, wherein the fourth electrode is arranged downstream of the second roller. In this case, it possible to apply a compensation charge to the film from both sides, if at least one electrode each is provided on both sides of the film, so that the charge shift within in the film can be fully compensated. Subsequently, the film can be further processed without charge, for example, rolled up. Measuring equipment for characterizing the film can also be operated unaffected by electrical charges. Preferably, a potential with periodically switching polarity is applied to the at least one fourth electrode so that an alternating-current voltage is brought about. This particularly reliably compensates the charge of the film. A plurality of fourth electrodes may again be provided on one side or on both sides of the film, wherein the electrical potentials can again be different, as already described in connection with the first, the second and the third electrodes. A potential is preferably applied to the fourth electrodes so that, relative to earth, a voltage between 1 and 10 kV (kilo volt) is generated.

In a further embodiment of the invention, at least one measuring device for measuring the electrical charge and/or the electrical voltage of the film is provided to be able to measure the charge of the film on one or on both sides (front and/or back). A measuring device may be a measuring bar with a plurality of individual measuring points or with a measuring element extending over the entire transverse direction, which measuring bar extends in the transverse direction of the film. However, a single or a group of measuring points may also be provided, which measuring points can be moved across the film by means of a traversing device. Such traversing devices are known to the person skilled in the art from measuring devices for measuring film thickness profiles.

The measuring result can be used, for example, for open-loop or even closed-loop control of the compensation charge. Also, some or all of the electrodes can be open-loop or closed-loop controlled with regard to the set potential. While open-loop control may be carried out by the operating personnel, a computing and control device, which repeatedly compares the measurement results with target values and adjusts the application of electrical potentials and/or electrical currents to at least some of the electrodes in the event of deviations above a tolerance range, is advantageous for closed-loop control. For the comparison, the forming of the target value and/or the forming of the tolerance range, the computing and control device can take further parameters into account such as the stretch ratio of the film, the web velocity or the intrinsic properties of the film (material composition, number of layers, total thickness etc.). Other measurement values such as the measurement values of the thickness of the film may also be included in the control parameters.

In an advantageous embodiment of the invention, at least part of the electrodes can be subjected to a voltage to earth of between 5 and 60 kV. At these voltages, the electrodes are supplied with an electrical current of preferably between 1 and 50 mA.

One or, in particular a plurality of, high-voltage generators may be provided for each electrode. A plurality of generators have an amplifying effect. In connection with the open-loop or closed-loop control described above, it may be provided that at least one first generator is open-loop controlled with regard to its voltage and at least one generator is closed-loop controlled with regard to its charging current. This results is a more stable control.

A preferred embodiment of the invention includes that at least part of the electrodes are adjustable with regard to their effective width. This means that the operative effect, meaning the applying of a potential, does not extend across the full width of the roller but only in a section thereof. Additional, this makes it also possible, to adjust the effective width to the width of the film. This makes it possible to charge the film more effectively, especially in the edge areas.

To realize these advantages, it may be provided to connect needles, pins or individual wires, each of which emits an electric field, individually or in groups, so that parts of the electrodes can be switched on or off. Electrically insulating covers, which can be inserted between said electrical conductors and the film, may also be provided. Said covers may be, for example, plastic plates that can be arranged on the electrode housing. To realize the above advantages, insulating cover elements, with which sections of the roller or the film can be covered, may also be provided. Such cover elements may be directly or indirectly arranged on the machine frame, for example, releasably and/or displaceably. Alternatively or additionally, it may be provided to fasten individual electrical conductors or groups of electrical conductors to support elements, wherein two support elements in each case can be arranged so that they are displaceable relative to each other in the transverse direction of the film. Instead of one electrode, two separate electrodes, each smaller than the width of the roller but equal to or greater than half the width of the roller, may be arranged next to each other and slightly offset in the transport direction of the film. Said electrodes then form an electrode pair and may be displaceable relative to one another in the transverse direction so that the electrode pair can be adjusted to various film widths.

It is also conceivable that one electrode having a smaller width than the width of the roller is provided. Such an electrode may be mounted so as to be displaceable in the axial direction of the roller and can be periodically moved back-and-forth parallel to the roller axis during operation (traversing).

In order to achieve a more effective application of an electrical potential to the edge regions of the film, it may be provided that the electrode is only arranged in one of these edge regions. To adapt to the width of the film, said electrode can, of course, be mounted so that it can be displaced transversely to the transport direction of the film.

In an advantageous embodiment, it is provided that the distance of at least one of the electrodes to the film is variable. If the electrode is arranged in the region of one of the rollers, this refers to a change in the radial direction of the roller. If the film runs along a plane in the region in which the electrode is arranged, a change in the direction orthogonal to the plane of the film is meant. Instead of the entire electrode, parts of the electrode may be radially displaceable. This means, that different sections of the electrode can assume different distances to the film in the traverse direction relative to the transport direction. This makes it easier to react to different properties of the film in its transverse direction. By changing the distance of the electrode or its sections to the film it is possible to not only to vary the voltage applied to the film, but also the course of the electric field on the film. The distance can be changed by means of adjustment means that, for example, facilitate a displacement of the electrode along rails. The distance can be changed by influencing it manually or automatically, i.e., in a motorized manner. In the case of, in particular, an automatic change, the change in distance can be controlled by the computing and control device, in particular by the control unit as part of a closed-loop control.

Furthermore, it is advantageous if the housing and thus the electrical conductors of the electrode can be variable in their angular position relative to the vertical on the film. It can therefore be said that if you look into the plane of the film, the electrodes can be tilted to the right or left. This way, the shape of the electric field on the surface of the film can be changed. This makes it possible, in particular in the case of very small stretching gaps, to introduce the electric field into the stretching gap. The angular position of the electrode can also be changed manually or automatically, in particular as part of closed-loop controlling.

It is further advantageous if the electrode, if it is arranged in the region of one of the rollers, is pivotably mounted in the circumferential direction of the roller. With variable roller positions, in particular of the first and the second roller, the positions of the leading edge and/or the release edge can change. Said measure makes it possible to move the electrode closer to the leading edge or to the release edge.

It is advantageous, if the electrode can be moved into a cleaning and/or starting position, in which the electrode has a large distance of at least 50 cm to the roller surface or to the transport path of the film between the two rollers. This way, cleaning the roller and/or drawing the film into the stretching device as part of starting up the stretching device is made easier.

Additionally, a drive may be provided for moving the electrode into the cleaning and/or starting position without manual intervention. The other position changes of the electrode described above can also be carried out without manual intervention by means of at least one drive. A position change can be triggered by the computing and control device, for example, when a web brake is detected via a web break sensor.

In the stretching device according to the invention a cleaning unit for cleaning the peripheral surface of at least one roller may be provided. By periodically measuring the current to or within at least one electrode and/or to or within at least one roller, anomalies can be determined. For example, a change in current identified over time can provide in indication that one of the rollers or electrodes is dirty. This indication can be displayed to the operating personnel on a display device so that the operating personnel can initiate or carryout a cleaning.

Finally, the electrode may be rotatable about the orthogonal of the film for fine positioning.

In a stretching device according to the invention, machine frame elements may be provided in which/from which contacting rollers can be mounted/removed. In this case, it may additionally be provided that at least some of the electrodes can be exchanged. This measure allows at least one electrode to be exchanged for a contacting roller. The function principle of contacting rollers is disclosed in patent document EP 2 498 976 B1, which is hereby deemed to be incorporated in this application. The advantage is that the most suitable means for reducing neck-in and constriction within a stretching device can be used even for different types of film. A contacting roller may be provided, in particular, at the leading edge of one roller or both rollers, preferably the first roller, to minimize the entrainment of air between the film and the roller as already described above.

In a further advantageous embodiment of the invention, it is provided that the first and/or the second roller comprise apertures in their surface, to which apertures a vacuum can be applied. This allows for the force acting on the film in the direction of the roller surface to be increased even further, so that the positive effects of the invention can become even more pronounced, in particular responsive to the properties of the film. If such a roller has a coating as described above, it is additionally provided that said coating is permeable to air.

A stretching device according to the invention can be particularly advantageously combined with a blow film line, but also with a cast film line. With these lines, it is possible to influence the edge thickening and/or the neck-in and thus this effect within the stretching device during film production from plastic melts by means of suitable closed-loop or open-loop control of the film profile. The properties of the electrodes and/or rollers and their electrical operating parameters can be taken into account for the closed-loop or open-loop control of the film profile. Conversely, machine and production parameters of the film within the blow film or flat film machine can be used for setting the electrical parameters within the stretching device, in particular, if said electrical parameters are controlled by the computing and control device.

However, the stretching device according to the invention can also process a film that is provided as a film wound onto a roll which is unwound in an unwinding device in an advantageous manner. The film parameters for each roll can be stored, for example in a roll log, and fed to the stretching device's computing and control device. This way electrical machine or operating parameters can be set for each position of the film along its longitudinal direction to optimally achieve the object stated above.

Films that can be processed in the stretching device can, for example, be so-called “breathable films” (i.e., films with through openings for the targeted passage of gases), but also barrier films. However, films may, in particular, also be blocked or unblocked films containing polyethylene.

The object stated above is additionally achieved by a method for stretching a plastic film in its transport direction, wherein the plastic film is guided over a first roller (SD), wherein the roller is driven with a first drive and rotates at a first circumferential speed, and wherein the plastic film is guided over a second roller (FD), wherein the roller is driven with a second drive and rotates at a second circumferential speed, wherein the second circumferential speed is greater than the first circumferential speed, wherein, in the transport path of the plastic film, the second roller is arranged downstream of the first roller so that the plastic film is stretched in the free region between the first and the second roller.

The method according to the invention is characterized in that, in the angular region of the first roller, on which the plastic film rests and/or upstream of said angular region, the plastic film is subjected to an electrical field by means of at least one first electrode, wherein a first electrical potential is applied to the electrode, and in that a second electrical potential is applied to the first roller. The method according to the invention achieves the same advantages as have already been described in connection with the stretching device according to the invention.

Further advantages, features and details of the invention are shown in the following description, in which various exemplary embodiments are explained in detail with reference to the figures. The features mentioned in the claims and in the description can each be essential to the invention individually or in any combination of features mentioned. Within the scope of the entire disclosure, features and details that are described in connection with the method according to the invention naturally also apply in connection with the stretching device according to the invention and vice versa, so that reference is or can always be made reciprocally to the individual aspects of the invention with regard to the disclosure. The individual figures show:

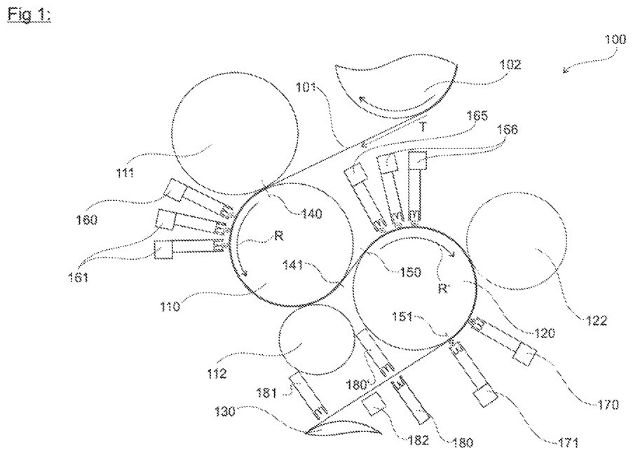

FIG. 1 a schematic view of a stretching device according to the invention;

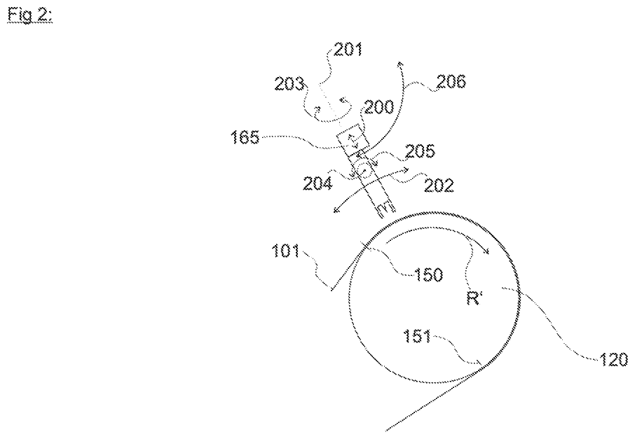

FIG. 2 an enlarged section of FIG. 1;

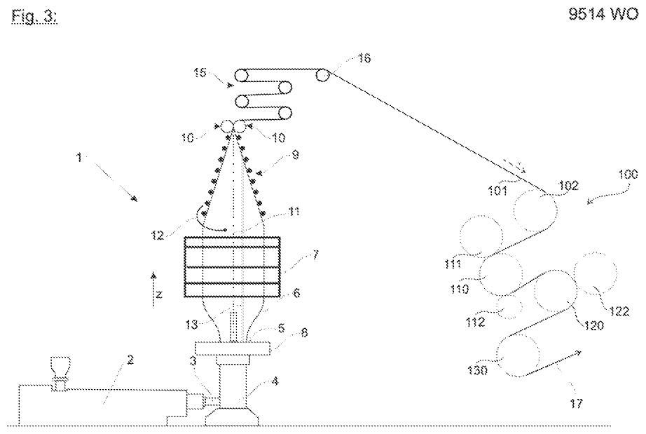

FIG. 3 a blow film line comprising a stretching device according to the invention,

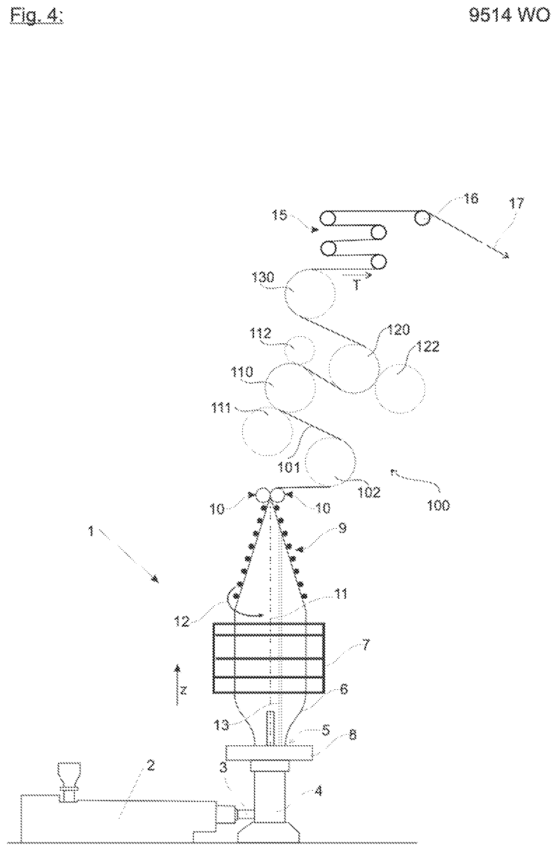

FIG. 4 a another blow film line according to the invention comprising a stretching device.

FIG. 1 shows of a schematic representation of a stretching device 100 according to the invention. The web-like plastic film 101 runs into the stretching device 100 in the transport direction T. The plastic film initially runs onto one or consecutively onto a plurality of preheating roller/s of which only one preheating roller 102 is shown. The purpose of the preheating roller is to bring the film to a predefined temperature. For this purpose, the preheating roller is generally heated, whereby often a heated fluid is introduced into the preheating roller.

After leaving the preheating roller(s) 102, the film web 101 arrives on a first roller 110, which generally can also be referred to as the first stretching roller 110. Said stretching roller is connected to a drive (not shown), for example, a dedicated electric motor which rotatably drives the roller 110 at a first circumferential speed in the direction of the arrow R. Said roller can also be referred to as SD roller (SD stands for slow drive). The film runs onto the first roller 110 at the leading edge 140. Ideally, said leading edge 140 perpendicularly extends as a line into the drawing plane. In praxis, the leading edge frequently deviates from normal.

A first contacting roller 111 is preferably associated with the first roller 110, which contacting roller together with the first roller 110 provides an inlet gap for the film. Said inlet gap or the running path of the film 101 is preferably configured such that said film 101 runs in the inlet gap tangentially relative to the rollers 110, 111. In other words, the inlet gap coincides with the leading edge. The roller gap already serves to minimize the air between the stretching roller 110 and the film 101. The roller gap also serves to make the leading edge straighter.

Optionally, a second contacting roller 112 is associated with the first roller 110, which second contacting roller forms an outlet gap with the roller 110. The second contacting roller 112 may be adjustable in the circumferential direction of the first roller 110. The second contacting roller 112 serves to cause the film to leave the first roller 110 along a line running parallel to the axial direction of the roller 110. For reasons of space, however, the actual release edge 141 is often located behind the second contacting roller 112. The film leaves the first roller 110 at the release edge 141. Ideally, said release edge 141 perpendicularly extends as a line into the drawing plane. In praxis, the release edge also frequently deviates from a straight line. In particular these deviations lead to the edge thickening and neck-in effects described above.

The region between the leading edge 140 and the release edge 141 is the angular region of the roller 110 on which the film rests, i.e., the wrap angle of the first roller 110.

Viewed in the transport direction T of the film 101, a second roller 120 is arranged downstream, which can be referred to as second stretching roller 120. Said stretching roller 120, too, is connected to a further drive (not shown), for example, a dedicated electric motor which rotatably drives the roller 120 at a second circumferential speed in the direction of the arrow R. The second stretching roller has a higher circumferential speed then the first stretching roller, which is why it can also be referred to as an FD roller (FD stands for fast drive). This results in the film 101 being stretched in its transport direction between the release edge 141 of the first roller 110 and the leading edge 150 of the second roller 120 in the ratio of the circumferential speeds. The distance between the outlet gap and the leading edge is often also referred to as stretching gap.

It is possible that the first roller 110 and the second roller 120 are movable relative to one another. This allows the stretching gap to be influenced. Changing the stretching gap can affect the properties of the film.

Moreover, a third contacting roller 122 is optionally associated with the second roller 120, which third contacting roller forms an outlet gap with the roller 120. The third contacting roller 122 may be also adjustable in the circumferential direction of the second roller 120. The third contacting roller 122 serves to cause the film to leave the second roller 120 along the release edge 151 running parallel to the axial direction of the roller 120. For reasons of space, however, the actual release edge 151 is often located behind the third contacting roller 122. Ideally, said release edge 151 perpendicularly extends as a line into the drawing plane. In praxis, the release edge 151 here also frequently deviates from normal.

The region between the leading edge 150 and the release edge 151 is the angular region of the roller 120 on which the film rests, i.e., the wrap angle of the second roller 120.

In principle, one or more contacting rollers can also be dispensed with in a stretching device according to the invention. Nevertheless, there may be an inlet gap or outlet gap.

Further stretching rollers may be provided, in particular, with one or two contacting rollers each, wherein two stretching rollers arranged directly one after the other are driven such that the downstream stretching roller has a higher circumferential speed than the preceding stretching roller.

Downstream of the stretching roller 110, 120, a cooling roller 130 is arranged with which the film 101 can be cooled down again so that the new molecular orientation created by stretching solidifies within the film.

To increase the retaining force of the film on the roller, a first electrode 160 may be provided in the region of the wrap angle of the first roller 110 or upstream thereof, which electrode adds an electrical charge to the side of the film facing it and/or induces a charge shift within the film. In FIG. 1, this is symbolized by a “−” sign in an ellipse. Any number of further electrodes 161 may be arranged downstream of a first electrode. In FIG. 1, two further electrodes are shown. Each of the first electrodes may be arranged upstream or downstream of the optional contacting roller 112 in the transport direction T of the film.

Likewise, a second electrode 165 may be provided in the region of the wrap angle of the second roller 120, which electrode adds an electrical charge to the side of the film facing it and/or induces a charge shift within the film. In FIG. 1, this is symbolized by a “−” sign in an ellipse, which means that the polarity of the charge or the charge shift corresponds to the one caused by the electrode 160 or 161. Any number of further electrodes 166 may be arranged downstream of a first electrode. In FIG. 1, two further electrodes are shown. The second electrode 165 or 166 also subject the film to the same polarity as the electrodes 160 and 161, respectively. However, now the side of the film that contacted the roller 110 is affected. It is advantageous, when the electrode 165 acts on the film as close to the leading edge 150 as possible.

Upstream of the release edge 151 of the second roller 120, a further electrode 170 is directed toward the film, which also applies charges to the film or causes charge shifts within the film. However, the polarity of the potential of the electrode 170 is reversed to that of the previous electrodes 160, 161, 165 and 166, which is shown with the “+” sign. This reduces the charge of the film or the charge shift within the electrode or compensates for it as completely as possible.

Alternatively or additionally, an electrode 171 is provided which preferably is arranged in the region of the release edge 151. The operating principle corresponds to that of electrode 170.

The film may still be electrically charged after leaving the second roller 120 at the release edge 151. To reduce this charge and to be able to transport and/or process the film in a practically electrically neutral manner, at least one further electrode 180, 180′ is provided. Preferably two further electrodes are provided opposite one another, between which the film is transported. Contrary to the electrode described above, it is preferably provided that an alternating-current voltage is applied to the electrode 180, 180′. Further electrodes 181 may be provided if the charge of the film has not yet been compensated.

To be able to determine the charge of the film, at least one charge meter 182 is provided which is preferably arranged downstream of the release point 151. Said charge meter may be provided upstream or downstream of the electrode 180, 180′, in the case of a plurality of charge meters, at both positions. Meters 182 may be provided on both sides of the film to be able to determine the charge of the film on both of its surfaces. The meter 182 may be provided not only for determining whether the charge compensation has been completed, but it may also be configured to determine the local charge of the film across its width on a surface.

FIG. 2 is an enlarged section of FIG. 1 and, using electrode 165, shows the possible position changes of any electrode. First, the electrode can be moved in a direction perpendicular to the plane spanned by the film or, if the film rests on a roller, perpendicular to the tangential plane, as shown by the double arrow 200. For this purpose, a first adjustment mechanism, which is not shown in the Figure, may be provided in the stretching device. The normal to the tangent plane 201 is shown as a dotted line.

To bring the electrode to specific points of the film, it is provided that the electrode is displaceable in the transport direction of the film. When the film runs on a roller, as shown in FIG. 2, the position of the electrode can be changed in the direction of the circumference of the roller 120. This is shown with arrow 202. The pivot axis preferably coincides with the axis of rotation of the roller 120. A corresponding pivot mechanism is provided but not shown.

To enable fine adjustment, the electrode is pivotable about normal relative to the tangent plane 201, as indicated with the double arrow 203.

Additionally, the electrode can be rotated about an axis of rotation 204 in the direction of the double arrow 205, wherein said axis of rotation 204 extends parallel to the plane of the film, but through the electrode.

Furthermore, the electrode may be pivotable about a second pivot axis (not shown) to be able to remove the electrode from the roller entirely. This measure is helpful to create room when, for example, the roller needs to be cleaned or a new film must be pulled into the stretching device. The second pivot axis is oriented, in particular, parallel to the axis of rotation, but outside of the roller and preferably outside of the electrode. This results in the pivot direction 206. However, the second pivot axis may be oriented differently, resulting in a different pivot direction.

FIG. 3 shows a device 1 for manufacturing a tubular film, namely a blow film line which firstly comprises at least one extruder 2 with which plastics material present in granular form, for example, can be plasticized. The plastic melt produced in this way is fed via a line 3 to an extrusion tool 4, which can also be referred to as a die head, from which this melt is transformed into a tubular film 6, so that this melt stream can be drawn out of an annular gap 5, which is not visible in this Figure, in the draw-off direction z. Now there is a tubular film 6 that has not yet solidified. Said tubular film is inflated from the inside by a slight overpressure so that it has a larger diameter inside the optional calibration device 7. The film tube is solidified, in particular, by a tempering device 8, which is often referred to as a cooling ring due to its ring-like design that surrounds the film tube.

After passing through the calibrating device, the tubular film 6 enters the effective working region of a laying-flat device 9, in which the circular tubular film is transformed into an elliptical cross-section with increasing eccentricity until it finally forms a double-layer plastic film, which is joined together at its sides, in the region of influence of the draw-off rollers 10.

The laying-flat device is rotatably arranged, wherein the axis of rotation is substantially flush with the tube axis 11, which is indicated in FIG. 1 as a dotdashed line. The rotatability of the laying-flat device is indicated with the arrow 12.

FIG. 3 furthermore shows a reversing device 15, the task of which is to guide the laid-flat tubular film from the laying-flat device to the stationary roller 16 without damages occurring.

Downstream of the reversing device 15, a stretching device 100 according to the invention is now arranged, which has already been explained in connection with FIGS. 1 to 2 and the preceding description. The stretching device shown in FIG. 3 may correspond to that shown in FIG. 1, although not all electrodes and measurement units are shown. It should also be noted that a cutting device may be positioned upstream of the stretching device 100, with which one or two edges of the fold can be cut open or cut off. In addition, a separating device may be provided with which the double-layer plastic film can be divided into one or more single-layer films.

The arrow 17 indicates that, after passing through the stretching device 100, said tubular film is guided to further processing, which is not specified in detail here.

FIG. 4 shows another embodiment of a blow film line according to the invention in which the stretching device 100 is now arranged between the draw-off rollers 10 and the reversing device 15. It should be noted that the rollers within the stretching device are now arranged in a sequence so that the plastic film can be transported from bottom to top.

Reference sign list

| | |
|---|---|
| 100 | Stretching device |
| 101 | Plastic film |
| 102 | Preheating roller |
| 110 | First roller |
| 111 | First contacting roller |
| 112 | Second contacting roller |
| 120 | Second stretching roller |
| 122 | Second contacting roller |
| 130 | Cooling roller |
| 140 | Leading edge |
| 141 | Release edge |
| 150 | Leading edge |
| 151 | Release edge |
| 160 | First electrode |
| 161 | Further electrodes |
| 165 | Second electrode |
| 166 | Further electrodes |
| 170 | Electrode |
| 171 | Electrode |
| 180 | Electrode |
| 180′ | |
| 181 | Electrode |
| 182 | Charge meter |
| 200 | Double arrow |
| 201 | Tangent plane |
| 202 | Arrow |
| 203 | Double arrow |
| 204 | Axis of rotation |
| 205 | Double arrow |
| 206 | Pivot direction |

| | |
|---|---|
| 1 | Device for manufacturing a tubular film |
| 2 | Extruder |
| 3 | Line |
| 4 | Extrusion tool |
| 5 | Non-visible annular gap |
| 6 | Tubular film not yet solidified |
| 7 | Optional calibration device |
| 8 | Tempering device |
| 9 | Laying-flat device |
| 10 | Draw-off rollers |
| 11 | Tube axis |
| 12 | Arrow for illustrating the rotation of the laying-flat device |
| 13 | |
| 14 | |
| 15 | Reversing mechanism |
| 16 | Stationary roller |
| 17 | Arrow for indicating further processing |
| R R′ | Arrow |
| T | Transport direction |
| Z | Draw-off direction |

1. A stretching device for stretching a plastic film in its the transport direction, comprising a first roller (SD) over which the plastic film can be guided and which can be driven with a first drive and which can be rotated at a first circumferential speed, and comprising a second roller (FD) over which the plastic film can be guided and which can be driven with a second drive and which can be rotated at the second circumferential speed, wherein the second circumferential speed is greater than the first circumferential speed,
wherein the second roller is arranged downstream of the first roller in the transport path of the plastic film, so that the plastic film can be stretched in the free region between the first and the second roller, characterized in that
at least one first electrode, to which a first electrical potential can be applied and which is arranged in the angular region of the first roller on which the plastic film rests, and/or upstream of said angular region, and
that a second electrical potential can be applied to the first roller.

2. The stretching device according to claim 1,
characterized in that
at least one second electrode, to which a third electrical potential can be applied and which is arranged in the angular region of the second roller on which the plastic film rests, and
that a fourth electrical potential can be applied to the second roller.

3. The stretching device according to claim 1,
characterized in that
at least one third electrode is provided to which a fifth electrical potential can be applied and which is arranged in the angular region of the second roller, on which the plastic film rests, and downstream of the second electrode, wherein the fifth electrical potential has a reverse polarity compared to the third potential.

4. The stretching device according to claim 1,
characterized in that
at least one fourth electrode is provided to which a sixth electrical potential can be applied, wherein the fourth electrode is arranged downstream of the second roller.

5. The stretching device according to claim 1,
characterized in that
the distance of at least one of the electrodes to the film is variable.

6. The stretching device according to claim 1,
characterized in that
the width of at least one of the electrodes is variable.

7. The stretching device according to claim 1,
characterized in that
the angular position of at least one of the electrodes, which are arranged in an angular region of a roller on which the film rests, is variable.

8. A method for stretching a plastic film in its transport direction,
wherein the plastic film is guided over a first roller (SD), wherein the roller is driven with a first drive and rotates at a first circumferential speed, and
wherein the plastic film is guided over a second roller (FD), wherein the roller is driven with a second drive and rotates at a second circumferential speed, wherein the second circumferential speed is greater than the first circumferential speed,
wherein the second roller is arranged downstream of the first roller in the transport path of the plastic film, so that the plastic film is stretched in the free region between the first and the second roller, characterized in that
in the angular region of the first roller, on which the plastic film rests and/or upstream of said angular region, the plastic film is subjected to an electrical field by means of at least one first electrode, wherein a first electrical potential is applied to the electrode, and that a second electrical potential is applied to the first roller.
